(19) United States
(12) Patent Application Publication
(10) Pub. No.: US 2005/0288074 A1
(43) Pub. Date: Dec. 29, 2005

(54) Movable radio communication apparatus

(76) Inventors: Yuji Kinuzawa, Sapporo (JP); Masaru Kanazawa, Kawasaki (JP)

Correspondence Address: KATTEN MUCHIN ROSENMAN LLP, 575 MADISON AVENUE, NEW YORK, NY, 10022-2585, US

(21) Appl. No.: 11/207,282

(22) Filed: Aug. 19, 2005

Related U.S. Application Data
(62) Division of application No. 10/787,357, filed on Feb. 25, 2004.

(30) Foreign Application Priority Data
Mar. 27, 2003 (JP) 2003-088923

(51) Int. Cl. H04M 1/00

(52) U.S. Cl. 455/575.3

(57) ABSTRACT

A movable radio communication apparatus includes a speaker that outputs communicatee's voices, a first housing that accommodates the speaker, an antenna part that communicates with an external apparatus, and a second housing coupled to the first housing and foldable relative to the first housing, the second housing accommodating the antenna part.

This application claims the right of priority under 35 U.S.C. §119 based on Japanese Patent Application No. 2003-088923, filed on Mar. 27, 2003, which is hereby incorporated by reference herein in its entirety as if fully set forth herein.

### BACKGROUND OF THE INVENTION

The present invention relates generally to an electronic apparatus, and more particularly to a personal digital cellular (“PDC”), a personal handy phone system (“PHS”), and another mobile communication terminal, which are generally referred to as “mobile radio communication apparatuses” in the instant application.

Along with recent widespread of the mobile radio communication apparatuses, such as PDCs, various demands have been made on them including a smaller housing, a versatile apparatus, high-quality and multifunctional communications, improved safety, etc. in addition to mere communications.

FIGS. 8 and 9 show one example of a conventional PDC. Here, FIG. 8A is a front view of the conventional PDC 10, FIG. 8B is its rear view, and FIG. 8C is its side view. FIG. 9 is a side view for explaining use of the PDC 10.

As shown in FIG. 8, the PDC 10 includes a speaker 12 and a display 13 at upper portions of a housing 11, an operation part 14 and a microphone 15 at lower portions of the housing 11, a helical antenna 16 that projects from the top of the housing 11 and winds wire in a coil shape, a built-in antenna 17 in the housing 11, and a battery 18 at a lower back portion of the housing 11. The built-in antenna 17 includes a patch antenna made of a sheet metal, etc., a chip multilayer antenna formed in a multilayer substrate, a dielectric antenna made of dielectric, etc. Thus, the antenna member generally projects from the top of the housing 11 of the PDC 10 or is built inside the housing 11 for stable communication states during calling, because these portions preferably have as few obstacles as possible.

In use, a user arranges the PDC 10 close to his ear and places a call, as shown in FIG. 9, using the speaker 12 and the microphone 15. Use of a flipper has been known to enhance a sidetone function (see, for example, Japanese Patent Applications Publications Nos. 2001-102833, 2001-358514, and 2002-34329). Additions of Global Positioning System (“GPS”) and Bluetooth functions have been known as an example of the multifunctional communication. An addition of a camera function has been known as the versatile apparatus.

However, the PDC 10 has a disadvantage in that it cannot always obtain high-quality communications, as shown in FIG. 9, because its antenna members 16 and 17 are close to a user's head, the head easily absorbs and reflects the electric waves, and thus the communication characteristics deteriorate. In addition, the PDC 10 has a safety problem of increased Specific Absorption Rate (“SAR”) as electric power absorbed in a specific portion of a human body. Moreover, the PDC 10 increases not only the number of antenna members with the increased number of functions such as GPS and Bluetooth communications, but also the number of components due to the multiple functions, such as a camera, in addition to radio equipment, disadvantageously making the housing 0.11 larger. On the other hand, as the housing 11 becomes smaller, the antenna member becomes close to a printed board for the display 13, the operation part 14, and the battery 18, deteriorating antenna performance and other circuits' characteristics.

### BRIEF SUMMARY OF THE INVENTION

Accordingly, it is an exemplified object of the present invention to provide a mobile radio communication apparatus that meets at least one of versatile apparatus, high-quality communication and improved safety.

In order to achieve the above object, a mobile radio communication apparatus of one aspect according to the present invention includes a speaker that outputs sounds, a first housing that accommodates the speaker, an antenna part that communicates with an external apparatus, and a second housing coupled to the first housing and foldable relative to the first housing, the second housing accommodating the antenna part. This mobile radio communication apparatus inclines the second housing relative to the first housing, thus inclines the second housing relative to a head of a user who locates the speaker close to his ear, and spaces the second housing from the head. Thus, this apparatus reduces SAR, and reflection and absorption amounts of the electric waves by the user's head.

The movable radio communication apparatus may further include an operation part that inputs communication information, and the second housing may be provided opposite to the operation part with respect to the speaker. A user usually holds a rear surface of the operation part, and the second housing distant from there can reduce reflections or absorptions of the electric waves by the user's hand.

The second housing forms an angle, for example, between 90° and 135° relative to the first housing. This angle range is preferable to reduce reflections or absorptions of the electric waves by the user's head and hand holding the first housing.

A movable radio communication apparatus of another aspect according to the present invention includes a speaker that outputs sounds, a first housing that accommodates the speaker, an operation part that inputs communication information, and a second housing, provided opposite to the operation part with respect to the speaker, coupled to the first housing, and foldable relative to the first housing. This movable radio communication apparatus uses the second housing to accommodate those components that have not conventionally been able to be housed in the first housing and make the apparatus multifunctional. On the other hand, the second housing is foldable relative to the first housing, and does not greatly harm the miniaturization of the entire apparatus.

The second housing can accommodate an antenna, such as a GPS antenna and a Bluetooth antenna, an image pickup device, etc. The movable radio communication apparatus may further include a display that displays communication information. An antenna part in a common movable radio communication apparatus restricts a size of the display, but these members are now housed in separate housings to make the display larger effectively.

The movable radio communication apparatus may include a mechanism that flips the second housing. The second housing may be coupled rotatably to the first housing, and wherein the mechanism includes a forcing part that applies a force to the second housing so as to keep the second housing from the first housing, a fixing part that fixes the second housing onto the first housing, and a moving part movable between first and second positions, and forced to return from the second position to the first position, the moving part when located at the second position, releasing a fixation of the second housing by the fixing part, and the moving part when located at the first position, enabling the fixing part to fix the second housing. The moving part may be provided onto the first housing, like a push-button.

A movable radio communication apparatus of still another aspect according t the present invention includes a speaker that outputs communicatee's voices, a first housing that accommodates the speaker, an antenna part that communicates with an external apparatus, and a second housing coupled to the first housing and movable or displaceable relative to the first housing, the second housing accommodating the antenna part. This movable radio communication apparatus moves or displaces the second housing relative to the first housing, and can reduce SAR by the antenna part. If necessary, the second housing is detachable from the first housing.

A method of still another aspect according to the present invention for manufacturing a movable radio communication apparatus that includes a speaker that outputs communicatee's voices, and a first housing that accommodates the speaker, includes the steps of producing plural types of second housings, each of which is to be coupled to the first housing and foldable relative to the first housing, the second housing accommodating different types of function expansion members, each function expansion member expanding a function of the movable radio communication apparatus, and attaching one of the plural types of second housings to the first housing. This method attaches one of plural types of second housings to the first housing, and a user can select a mobile radio communication apparatus that includes the second housing equipped with desired function expansion member. In other words, the inventive manufacturing method can manufacture movable radio communication apparatuses according to various users' preferences. The expanded function includes, for example, an image-pickup function, a reading function, a printing function, a storage function, etc. in addition to a communication function, such as a GPS communication function and a Bluetooth communication function.

Other objects and further features of the present invention will become readily apparent from the following description of preferred embodiments with reference to the accompanying drawings.

### BRIEF DESCRIPTION OF THE DRAWINGS

FIG. 1 is plane, rear and side views of a PDC of one embodiment according to the present invention.

FIG. 2 is a rear perspective view of the PDC shown in FIG. 1.

FIG. 3 is an exploded perspective view of the PDC shown in FIG. 2.

FIG. 4 is a transparent perspective view of a damper shown in FIG. 3.

FIG. 5 is a transparent perspective view of the PDC shown in FIG. 1.

FIG. 6 is a side view for explaining use of the PDC shown in FIG. 1.

FIG. 7 is a side view for explaining a GPS communication function of the PDC shown in FIG. 1.

FIG. 8 is front, rear and side views of a conventional PDC.

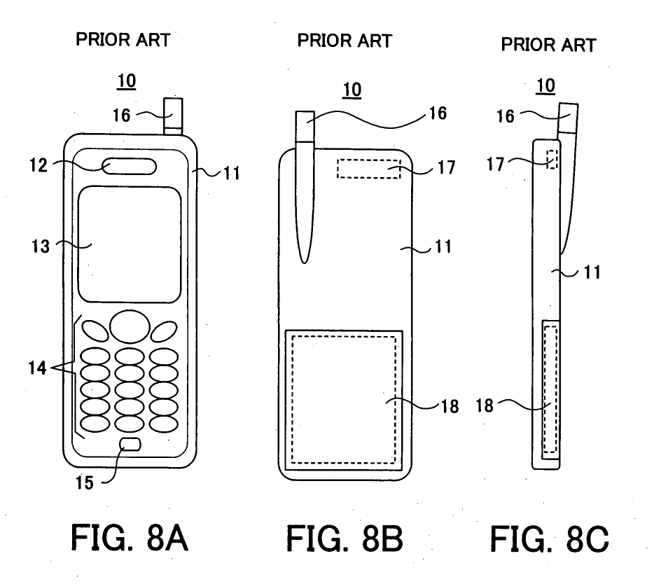

FIG. 9 is a side view for explaining use of the conventional PDC shown in FIG. 8.

### DETAILED DESCRIPTION OF THE PREFERRED EMBODIMENTS

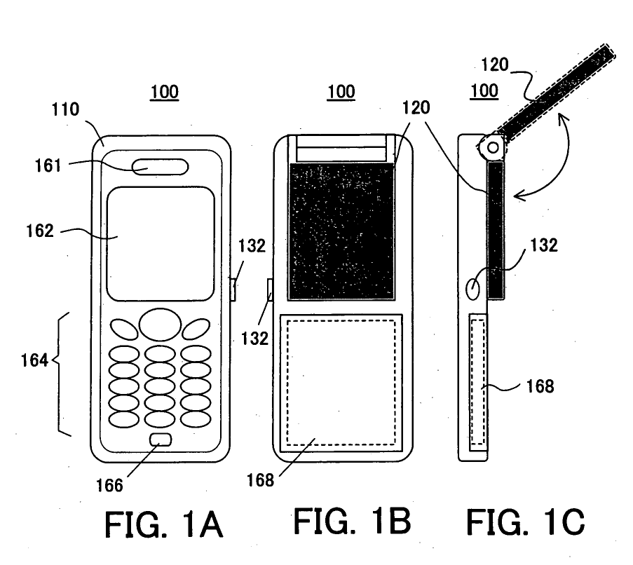

A description will be given of a mobile radio communication apparatus (“MRCA”) as one embodiment according to the present-invention, with reference to the accompanying drawings. The instant embodiment describes the PDC 100 as an example of the MRCA. Here, FIG. 1A is a plane view of the PDC 100, FIG. 1B is its rear view, and FIG. 1C is its side view.

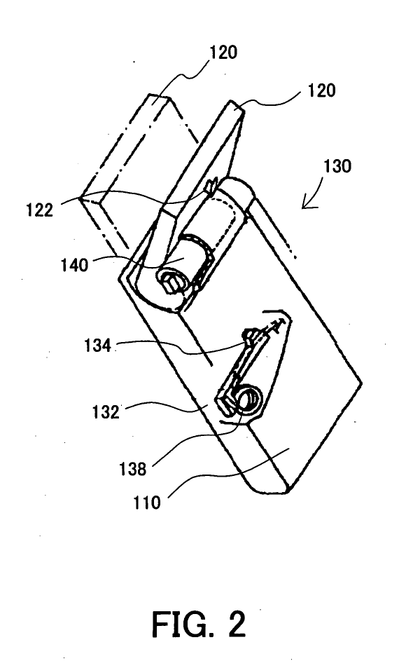

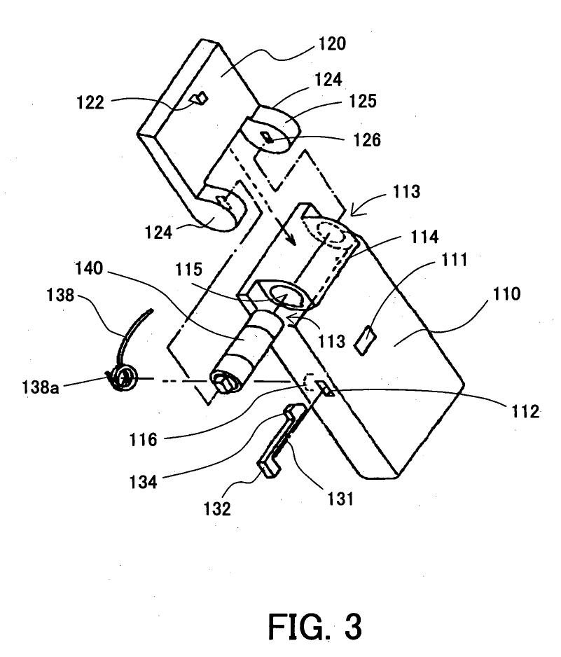

The PDC 100 includes the housing 110 and the flipper 120. The flipper 120 is coupled foldably to the housing 110 via an opening/closing mechanism 130. Referring now to FIGS. 2 to 4, a description will be given the opening/closing mechanism for the flipper 120. Here, FIG. 2 is a perspective view of the PDC 100 when the flipper 120 opens. FIG. 3 is an exploded perspective view of the PDC 100 viewed from its rear surface.

The housing 110 is made, for example, of resin by injection molding, and has holes 111 and 112, a concave 113, an engagement part 114, a perforation hole 115, and a fixing part 116. If necessary, the housing 110 of the PDC 100 can include two distinct, structurally foldable and unfoldable housings, i.e., a movable part that has a display 162, and a fixed part that has an operation part 164. Another flipper (not shown) may be provided at the bottom of the housing 110 to enhance a sidetone function.

The hole 111 is provided at a rear center of the housing 110, and a fastener 122 of a flipper 120 is inserted into the hole 111. The hole 111 has a rectangular shape in this embodiment, but its shape, side and position are not limited only if it can fix the fastener 122 of the flipper 120.

The hole 112 is provided on a side surface of the housing 110, and a button 132 is inserted into the hole 112. The instant embodiment arranges the hole 112 at an operable position by a thumb of a user's hand (for example, right hand) which holds the PDC 100 without changing a manner of holding, but the present invention does not limit a hole 112's shape, size and position. The fixing part 116 is provided near the hole 112 in the housing 110. The fixing part 116 is a fixing shaft engageable with a button assisting spring 138, and does not limit its shape, size and location.

The engagement part 114, which is provided on the upper rear surface of the housing 110, forms the concave 113 at both sides, and the perforation hole 115 in it. A damper 140 is rotatably inserted into the perforation hole 115 of the engagement part 114. The concaves 113 of the engagement part 114 enable both ends of the damper 140 to be engaged with the hole 125 of the projection part 124 at the both sides of the flipper 120. The concave 113 has a cylindrical surface similar to the cylindrical surface 125 of the projection part 124. Although the instant embodiment forms the engagement part 114 and the damper 140 separately, they may be integrated with each other.

The flipper 120 is a housing separate form the housing 110, and made, for example, resin by injection molding. The flipper 120 is coupled with the housing 110 so that the flipper 120 can open and close relative to the housing 110. The flipper 120 is connected t a rear surface of the housing 110 in FIG. 1C, but it may be connected to the front surface of the housing 110. The flipper 120 is formed at an end apart from the operation part 164 in the housing 110. This is because a user usually holds the rear surface of the operation part 164, and a position apart from the operation part 164 can reduce the absorption or reflection of the electric waves by the user's hand. Nevertheless, the present invention does not limit a location of the flipper 120.

The flipper 120 in the instant embodiment opens up, as shown in FIG. 1C, but the present invention does not limit its opening direction. In other words, since the instant embodiment can make SAR lower than the conventional method as the flipper 120 separates from the housing 110, the hinge part may be located at a lower part or side part instead of the upper part of the flipper 120. For this purpose, the flipper 120 does not have to rotate relative to the housing 110, but may have a linearly stretchable structure. For example, the housing 110 has a rail or rails along which the flipper 120 can move. When the flipper 120 moves linearly, the movement can be manual as in this embodiment or automatic.

The flipper 120 in this embodiment includes the fastener 122, and the pair of projection parts 124. The fastener 122 is provided at a distal end on the rear surface of the flipper 120, and enables the flipper 120 to be engaged with the housing 110. The fastener 122 has an exemplarily hook shape, but does not limit its size, position and shape.

A pair of projection parts 124 are provided at both ends of the base of the flipper 120, and have an approximately cylindrical shape. A cylinder surface 125 of this cylindrical shape is inserted into the concave 113, as shown in FIG. 2, and rotates on the concave 113. The pair of projection parts 124 sets the interval slightly wider than the width of the engagement part 114, contacts the engagement part 114 for smooth rotations when rotating on the housing 110. The pair of projection parts 124 have engagement holes 126 on facing surfaces. The engagement hole 126 is engaged with the damper 140, and rotates with the damper 140.

Thus, the projection part 124 enables the flipper 120 to rotate relative to the housing 110. The flipper 120 in the instant embodiment rotates using a pair of projection parts 124 at its both ends, but the flipper 120 may have another rotating member on the center of the projection part 124 and rotate instead of or with the projection part 124.

The opening/closing mechanism 130 includes a flipper lock member 131, the button assisting spring 138, and the damper 140. The flipper lock member 131 is a rod member that has a button 132 at one end, and a flipper engagement part 134 at the other end. The flipper lock member 131 serves to lock and unlock the flipper 120, and is inserted into the hole 112 in the housing 110.

The button 132 projects from the side surface of the housing 110, and is operated when a user attempts to open the flipper 120. The button 132 is provided on the housing 110 so that the button 132 can move between a projecting position relative to the housing 110 and a retreat position into the housing 110, as shown in FIGS. 1A and 1B. The button 132 is engaged with an engagement part 138a of the button assisting spring 138 at its rear surface, and forced towards the projecting position by the button assisting spring 138. As a result, the button 132 automatically resets to the projecting position even when pressed towards the housing 110. The button assisting spring 138 is fixed and engaged by the fixing part 116, and presses the button 132. Of course, a spring shape is not limited to the spring 138. For example, it may be a compression spring that has one end engaged with the housing 110, and the other end engaged with the button 132

The flipper engagement part 134 is engaged with the fastener 122, and locks the flipper 120 at the closed position when the button 132 is located at the projecting position, thereby maintaining the folded flipper 120 as shown in FIG. 1C. The flipper engagement part 134 disengages from the fastener 122 when the button 132 is located at a retreat position, allowing the flipper 120 to open. The fastener 122 of the flipper 120 and the flipper engagement part 134 do not limit their shapes, only if they can be engaged with each other when the button 132 is located at the projecting position, and disengaged from each other when the button 132 is located at the retreat position.

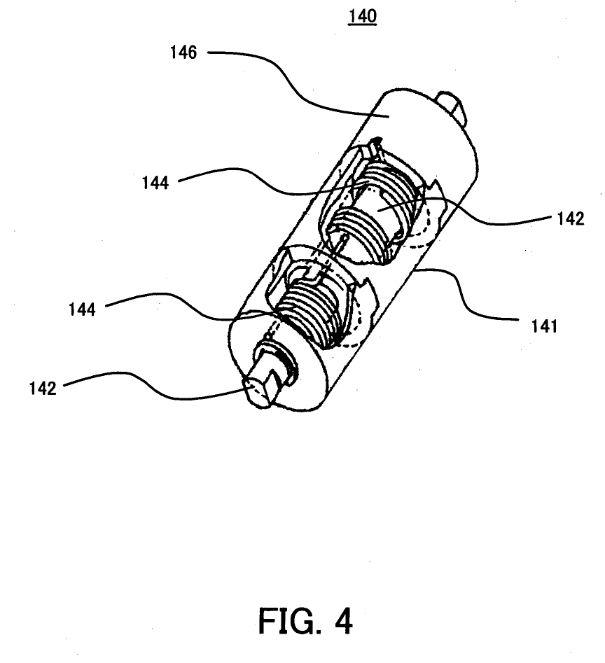

The damper 140 serves to force the flipper 120 so as to keep the flipper 120 from the housing 110, has a cylindrical shape, and is accommodated in the perforation hole 115 of the engagement part 114 of the housing 110. The damper 140 has, as shown in FIG. 4, a damper case 141, a rotary shaft 142, a torsion coil spring 144, and a rotary oil damper section 146. Here, FIG. 4 is a transparent perspective view of the damper 140.

The damper case 141 has a hollow cylindrical shape, and forms a pair of holes at both ends, into which the rotary shaft 142 projects. The rotary shaft 142 has an approximately cylindrical shape, and is provided in the damper case 141 so that the shaft 142 can rotate relative to the damper case 141. The rotary shaft 142 has a cylindrical shape with a small diameter at both ends, and projects from the damper case 141. Its top is processed into a rectangular section, and engaged with the engagement hole 126 in the flipper 120 so as to rotate with the flipper 120.

The torsion coil spring 144 is engaged with the rotary shaft 142 at one end and the damper case 141 at the other end, and forces the rotary shaft 142 in a reset direction when the rotary shaft 142 rotates relative to the damper case 141. The rotary oil damper section 146 contains brake oil, brakes an opening action of the flipper 120 to reduce the flipping speed, and serves to prevent the flipper 120 from getting damaged.

The housing 110 has a main printed board 160, a speaker 161, a display 162, an operation part 164, a microphone 166, and a battery 168.

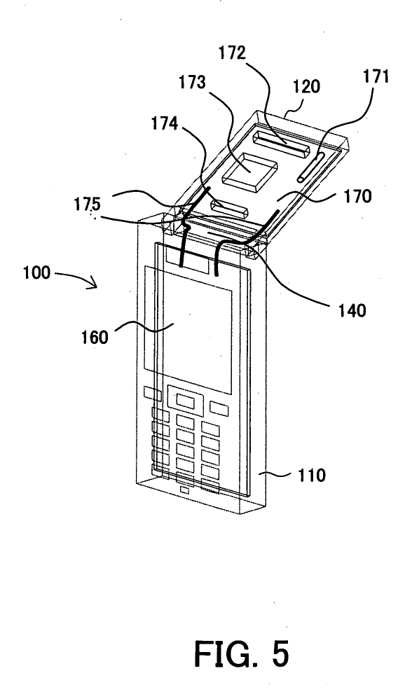

The main printed board 160 is provided in the housing 110, as shown in FIG. 5, connected to the speaker 160, the display 162, the operation part 164, the microphone 166, and the battery 168, and contains circuits to control or process these elements. Here, FIG. 5 is a transparent perspective view of the PDC 100.

The speaker 161 outputs communicatee's voices, and is designed to be located close to the user's ear. The display 162 is an LCD that indicates communication information (such as sending information, received information, address book information, information input by the operation part 164, and various functional information). The operation part 164 includes, for example, a touch panel, a ten-key, a function key, a power switch, and a reset switch. The microphone 166 inputs communicatee's voices. The battery 168 contains a secondary battery. These elements can use any technology known in the art, and a detailed description thereof will be omitted.

The flipper 120 includes a sub-printed board 170, a transmission/reception antenna 171, a built-in reception antenna 172, a GPS antenna 173, a Bluetooth antenna 174, a connector part 175 that connects the sub-printed board 170 to the main printed board 160.

The sub-printed board 170 is provided in the flipper 120, as shown in FIG. 5, and connected to the transmission/reception antenna 171, the built-in reception antenna 172, the GPS antenna 173, the Bluetooth antenna 174, and the connector part 175. The sub-printed board 170 contains a voice signal processor, a GPS signal processor, a Bluetooth signal processor, etc.

The transmission/reception antenna 171 projects from the flipper 120, and may be a helical antenna that winds wire into a coil shape, and other antenna (such as a dielectric antenna). The built-in reception antenna 172 covers a patch antenna made of a sheet metal, etc., a chip multilayer antenna formed in a multilayer substrate, a dielectric antenna made of dielectric, etc. The dielectric antenna can make the flipper 120 smaller. When antenna parts 171 and 172 are made built-in antennas, the degree of freedom of a design increases. The antenna parts 171 and 172 are located apart from the main printed board 160, and do not deteriorate antenna characteristics or damage the substrate 160.

The GPS antenna 173 is used for GPS communications, and the Bluetooth antenna 174 is used for Bluetooth communications. The flipper 120 can form an insertion opening through which a camera, a scanner and various cards. The connector part 175 is made, for example, of a cable line between substrates and a flexible printed board. The cable is, for example, a coaxial cable for use with high-frequency signal transmissions. The flexible printed board is used, for example, for various control signal transmissions. The connector part 175 connected to the sub-printed board 170 is connected to the main printed board 160 through the damper 140. The sub-printed board 170 communicates with main printed board 160, and is controlled by the main printed board 160.

Thus, the PDC 100 of the instant embodiment divides the conventional single housing 11 into two housings 110 and 120. The flipper 120 can accommodate those components that have conventionally not been able to be accommodated in the housing 11, and make the PDC 100 multifunctional. In addition, the flipper 120 is foldable over the housing 110, and does not excessively damage a compact appearance of the PDC 100.

The housing 110 can be made small by arranging in the flipper 120 those components to be accommodated in the conventional housing 11. Since the flipper 120 does not limit accommodated elements, the housing 110 can be made small by accommodating one or more of the speaker 161, display 162, the operation part 164, the microphone 166 and the battery 168 in the flipper 120. Alternatively, the housing 110 may maintain its size in this case, and each part in the housing 110 can be made larger, such as use of a larger display 162.

The antenna 16 in the conventional PDC 10 restricts a size of the display 13, whereas the PDC 100 of the instant embodiment effectively enlarge the display 161 by accommodating the display 161 and the antenna part 171 in two separate housings.

The component accommodated in the flipper 120 or the component for the purpose of versatility is not limited to the above GPS antenna 173, etc. For example, the PDC 100 can be produced according to users' preferences by combining with the housing 110 plural types of flippers 120 that accommodate different function expansion members.

In this case, a manufacture of the PDC 100 includes the steps of producing plural types of flippers 120, each of which accommodates different types of function expansion members, each of which expands a function of the PDC 100, and attaching one of the plural types of flippers 120 to the housing 110.

This method attaches one of plural types of flippers 120 to the housing 110, and thus a user can select a PDC 100 that has a flipper 120 equipped with desired function expansion member. This manufacture method can manufacture MRCAs according to users' various preferences. The expanded function can include a communication function, such as a GPS communication function and a Bluetooth communication function, an image-taking function, such as a camera, a reading function, such as a scanner, a printing function, such as a printer, a storage function, such as a memory, a security function, etc.

While the instant embodiment sets the angle P between 0° and 180°, the present invention does not prevent the flipper 120 from rotating by 180° or greater. In particular, when the camera function is attached to the flipper 120, a user confirms himself on the display 162 and conveniently takes his still or moving picture by rotating the flipper 120 by 180° or greater.

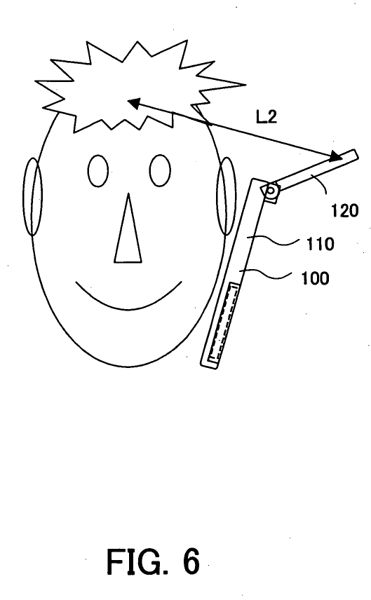

Referring now to FIGS. 1 and 6, a description will be given of an operation of the PDC 100. Here, FIG. 6 is a side view for explaining use of the PDC 100. As shown by dotted line in FIG. 1C and in FIG. 6, a user who attempts to use the PDC 100 presses the button 132 and flips the flipper 120 from the housing 110.

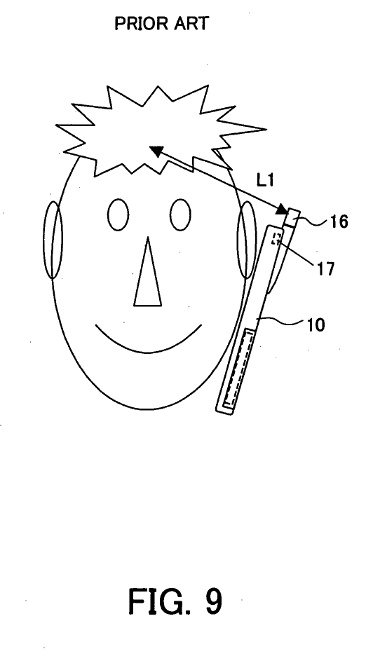

Thus, as shown in FIG. 6, a distance L2 between the flipper 120 and the user's head becomes greater than a distance L1 between the antenna 16 and the user's head in FIG. 9. Since SAR reduces for the user, the safety improves. In addition, the PDC 100 can reduce the reflection and absorption amounts of the electric waves by the user's head and thus the deterioration of the communication characteristics, obtaining the high-quality communication.

As shown in FIG. 1, when the flipper 120 opens, an angle between the flipper 120 and the housing 110 is set preferably between 90° and 135°. The deteriorated communication characteristics result from reflections and absorptions of the electric waves of a hand that holds the housing 110 as well as reflections and absorptions of the electric waves of the user's head. If an inclined angle P is smaller than 90°, influence by the user's hand would possibly increase although influence by the user's head might decrease. Therefore, the above angle range is preferable to reconcile reductions of both influences effectively.

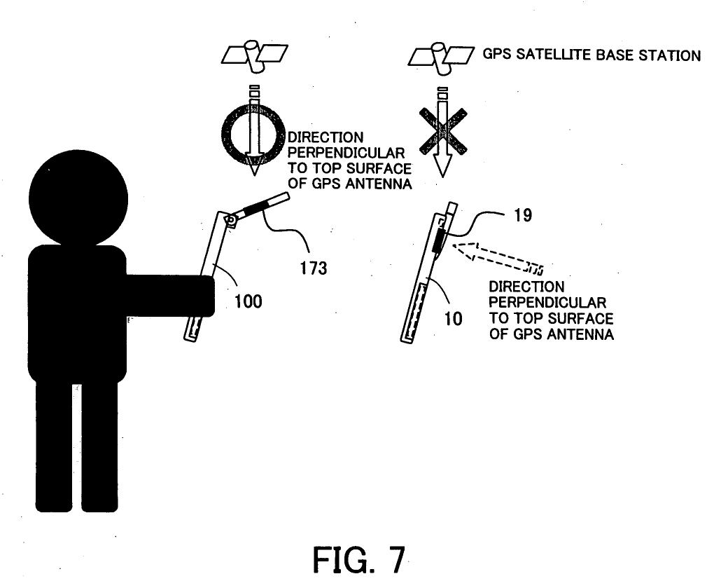

The flipper 120 is also opened even in using the GPS communication function of the PDC 100, as shown in FIG. 7. Here, FIG. 7 is a side view for explaining the GPS communication function of the PDC 100. When the conventional PDC 10 has a GPS antenna, the GPS antenna 19 is typically arranged on the rear surface of the housing. The user should angles the GPS antenna 19 vertically to receive information from GPS satellite that is located above. Therefore, the user has a difficulty in GPS communications while viewing the display 13 or operating the operating part 14.

On the other hand, the user of the PDC 100 of the instant embodiment improves operability because it merely flips the flipper 120 for GPS communications while viewing the display 162 or operating the operation part 164.

Further, the present invention is not limited to these preferred embodiments, and various variations and modifications may be made without departing from the scope of the present invention. For example, a mechanism in the instant embodiment for rotatably connecting the flipper 120 to the housing 110 may use other structures different from a button method, such as a manual opening/closing mechanism like a hinge mechanism for a laptop personal computer, and a push-push mechanism that fixes the flipper 120 at one push of the flipper 120 against the housing 110 and opens the flipper 120 from the housing 110 at another push of the flipper 120 against the housing 110.

Thus, the present invention can provide a mobile radio communication apparatus that meets at least one of versatile apparatus, high-quality communication and improved safety.

1-24. (canceled)

25. A method for manufacturing a movable radio communication apparatus that includes a speaker that outputs communicatee's voices, and a first housing that accommodates said speaker, said method comprising the steps of:
producing plural types of second housings, each of which is to be coupled to the first housing and foldable relative to the first housing, the second housing accommodating different types of function expansion members, each function expansion member expanding a function of the movable radio communication apparatus; and
attaching one of the plural types of second housings to the first housing.
